(19) United States
(12) Patent Application Publication
(10) Pub. No.: US 2005/0074541 A1
(43) Pub. Date: Apr. 7, 2005

(54) Rawhide biscuit and method for making the same

(76) Inventor: Steven Tsengas, Fairport Harbor, OH (US)

Correspondence Address: Law Offices of John D. Gugliotta, PE, Esq., 202 Delaware Building, 137 South Main Street, Akron, OH, 44308, US

(21) Appl. No.: 10/960,252

(22) Filed: Oct. 7, 2004

Related U.S. Application Data
(60) Provisional application No. 60/508,916, filed on Oct. 7, 2003.

(51) Int. Cl. A01K 1/00

(52) U.S. Cl. 426/658

(57) ABSTRACT

A process for making rawhide based biscuit products is provided on a mass production basis using a rotary molder. The biscuits may be produced in a variety of shapes such as individual strips, bone-shapes, chop shapes, triangular shapes, and the like. In addition, the pieces may be provided with logos or designs embossed in their surfaces.

### RELATED APPLICATIONS

The present invention claims the benefit of U.S. Provisional Patent No. 60/508,916, filed on Oct. 7, 2003, and incorporated by reference herein.

### BACKGROUND OF THE INVENTION

1. Field of the Invention

The present invention relates generally to dog biscuits and, more particularly, to the production of rawhide-based products using a rotary molder.

2. Description of the Related Art

Pet chews have been known for quite some time. A pet chew is a product that is intended to occupy an animal that may, or may not, be consumed. In particular, some pet chews are food-like products, which may have some nutritional value, and are often intended to clean a animal's teeth. Known pet chews are both hard and soft. Hard chews tend to be used in teeth cleaning by having the animal bite down on the chew to cause friction and to resultingly clean the teeth. Soft chews are intended to clean teeth and to occupy the animal's time by having the animal gnaw on the pet chew for a sustained period of time. Dogs are known to enjoy the chewing of such products.

A variety of different products are used to make pet chews of varying hardness. For example, in the past, pet chews have been made from animal hide. Animal hide chews, however, have a number of disadvantages associated therewith. In particular, animal hide can produce a foul odor as a result of being chewed. Moistening, as a result of chewing, will cause the hide to soften and degrade, whereby the chews can smear and stain carpets and furniture. More problematic, the rawhide can swell and cause blockage in an animal.

Additionally, the animal hide or raw hide can harbor bacteria, which can multiply in the mouth of an animal and be passed on to children, elderly people, or the immune impaired. As such, chews made from rawhide have been replaced by compositions that are “man made,” such as various starch and plastics based compositions.

A rotary molder is used to mold dog snacks or biscuits of “man made” compositions. The chewy dog snacks produced by such a processes may include a taste agent, fillers, fibers and nutrients.

The present invention provides a process for making rawhide based biscuit products on a mass production basis using a rotary molder. The biscuits of the present invention may be produced in a variety of shapes such as individual strips, bone-shapes, chop shapes, triangular shapes, and the like. In addition, the pieces may be provided with logos or designs embossed in their surfaces.

### SUMMARY OF THE INVENTION

The present invention provides a process for producing rawhide based products for human or canine consumption using a rotary molder. The use of a rotary molder enables the mass production of variously shaped jerky products with high meat content which may include logos or designs embossed in the surface of the product. The end product exhibits a distinctive, rugged appearance, are flexible, dense like naturally prepared rawhide, and are shelf stable for extended periods of time.

In accordance with the method of the present invention, modified grain starch is blended with hydrolyzed vegetable proteins, dextrine, and dried fermentation lactobacillus, casei and lactis solubles. Glycerine is added and heated at 60° C. While mixing, the starch becomes a jelly, and the preparation is then blended with rawhide powered that has been dissolved into water. At this point, other ingredients such as seasoning, flavorants, humectants, stabilizing agents or preservatives, palatability agents, fillers, and the like may be added as well. The combination is then blended into a homogeneous paste, or dough, that is then removed from the mixing vessel and fed into the hopper of a rotary molder. The rotary molder supports a plurality of mold dies about a cylinder, and the dough is forced between a scraper and the cylinder, into the dies as the cylinder revolves. A cloth belt conveyor comes into contact with the filled mold dies, and the dough sticks to the belt and is then pulled or extracted from the mold dies and conveyed to a baking pan, where a plurality of newly shaped biscuits are deposited and rack mounted to be transported to an oven. After baking at a sufficient temperature and time, the products are cooled and can be packaged.

The rotary moldable compositions may comprise at least about 40% by weight rawhide, based upon the total weight of the dough. In addition, the moisture content of the doughs during rotary molding is generally at least about 20% by weight, preferably from about 23.5% by weight based upon the weight of the dough. In embodiments of the invention, the amount of binding agent, preferably a cold water soluble starch is about 10% by weight based upon the weight of the rotary moldable dough.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 shows a process flow chart of a method for making a rotary molded rawhide biscuit product in accordance with the present invention.

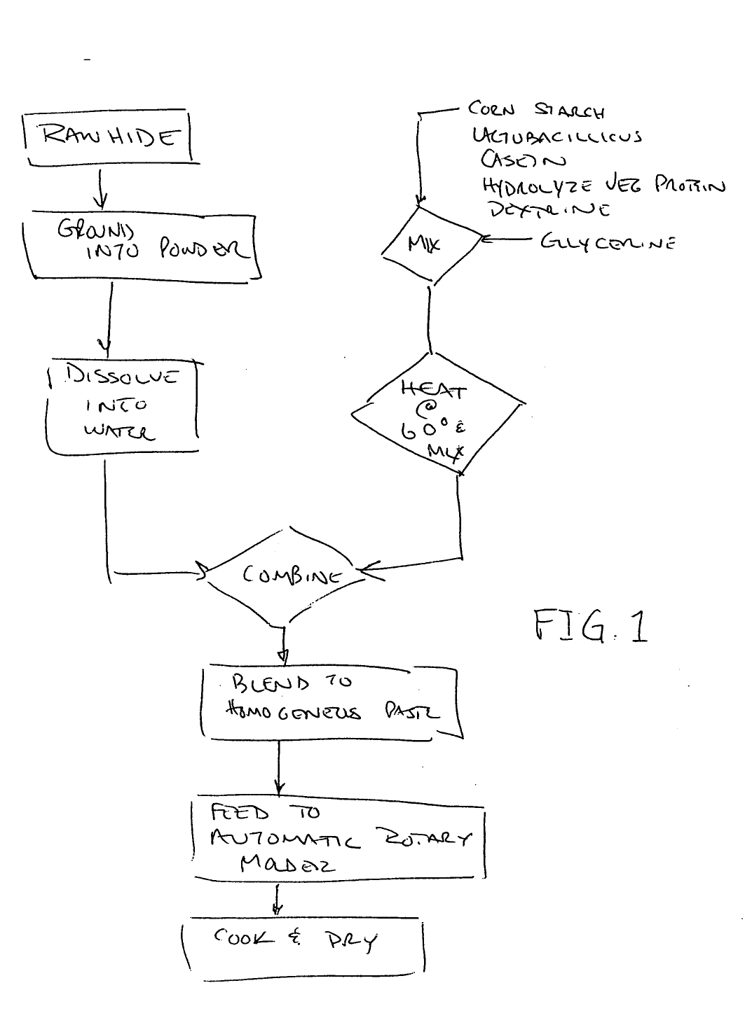

### DESCRIPTION OF THE PREFERRED EMBODIMENTS

The best mode for carrying out the invention is presented in terms of its preferred embodiment, herein depicted within the Figures

1. Detailed Description of the Figures

In accordance with the present invention, rawhide is ground into a powder and consists of 40.5% by weight based upon the weight of the rotary moldable dough, and is dissolved into enough water to be 20.5% by weight based upon the weight of the rotary moldable dough. Separately, the dry ingredients are blended and consist of:
modified corn starch of 10% by weight based upon the weight of the rotary moldable dough;
dextrine of 10% by weight based upon the weight of the rotary moldable dough;
casein of 5.0% by weight based upon the weight of the rotary moldable dough;
dried fermentation solubles, such as Acid-A-Pro(™) of 2% by weight based upon the weight of the rotary moldable dough;
calcium carbonate at 2.0% by weight based upon the weight of the rotary moldable dough; and
colors and flavorings of the balance of the weight based upon the weight of the rotary moldable dough.
   Glycerine is added to the dry ingredients at 3% by weight based upon the weight of the rotary moldable dough, and heated at 60° C. With heating and mixing, the starch is converted into a jelly-like consistency. Overheating of the jelly must be carefully avoided, in that the dried fermentation solubles, such as ACID-A-PRO(™) contain active bacteria that will not survive at higher temperatures. While mixing, the starch becomes a jelly, and the preparation is then blended with rawhide powered that has been dissolved into water.

At this point, other ingredients such as seasoning, flavorants, humectants, stabilizing agents or preservatives, palatability agents, fillers, and the like may be added as well. Exemplary seasoning and flavorings which may be included in the doughs of the present invention are one or more: 1) salts, such as sodium chloride and potassium chloride, 2) spices, for example, garlic, cloves, onion, chili pepper, black pepper, sweet basil, bay leaf, marjoram, parsley, sage, rosemary and thyme, 3) flavored foodstuffs, for example, cheese, cheese bits, cheese powder, eggs, egg bits, egg powder, bacon, bacon bits, and bacon powder, 4) flavorings such as bacon flavoring, fish flavoring, poultry flavoring, liquid smoke flavoring and/or airborne smoke, and 5) flavor enhancers such as monosodium glutamate. The combination is then blended into a homogeneous paste, or dough, that is then removed from the mixing vessel and fed into the hopper of a rotary molder. The rotary molder supports a plurality of mold dies about a cylinder, and the dough is forced between a scraper and the cylinder, into the dies as the cylinder revolves. A cloth belt conveyor comes into contact with the filled mold dies, and the dough sticks to the belt and is then pulled or extracted from the mold dies and conveyed to a baking pan, where a plurality of newly shaped biscuits are deposited and rack mounted to be transported to an oven. After baking at a sufficient temperature and time, the products are cooled and can be packaged.

Commercially available rotary molders may be used in the apparatus of the present invention, such as those produced by RotaMold Co., Twinsburg, Ohio. Generally, rotary molders include a feed hopper for feeding of a dough mass to a rotating feed drum. The rotating feeding drum can be corrugated or provided with a plurality of peripheral transverse ribs for feeding purposes. The rotating feed drum is mounted on bearings supported on a frame (not shown). Positioned adjacent to and in peripheral contact with the rotating feeding drum is a rotary molding drum or die roll. The rotary molding drum is provided with a plurality of molding cavities positioned in a particular arrangement about the peripheral surface of the rotary molding drum. Positioned beneath the rotary molding drum is a pressing drum or forming roll. A continuous web conveyor is supported on a plurality of guide rollers and fed between the rotary molding drum and the pressing drum. The continuous web conveyor may be made of a fabric-type composite material with which the individual dough pieces being formed preferentially adhere verses the inner surfaces of the molding cavities in order to remove the individual pieces therefrom. The individual dough pieces effectively adhere to the continuous web conveyor to maintain substantially the same pattern or alignment of the individual pieces as they had in the cavities of the rotary molder die roll.

A wiper or scraper blade may be used to remove any excess dough material extending above the molding cavities. The individual dough pieces formed in the molding cavities are transferred into and through the nip between the rotary molding drum and pressing drum to enable transferring and adhesion of the dough pieces to the continuous web conveyor.

After baking at a sufficient temperature and time, the products are cooled and can be packaged.

1. A rawhide-based product comprising:
rawhide that is ground into a powder and consists of 40.5% by weight based upon the weight;
water of 20.5% by weight;
modified corn starch of 10% by weight;
dextrine of 10% by weight;
casein of 5.0% by weight;
dried fermentation solubles of 2% by weight;
calcium carbonate at 2.0% by weight;
glycerine at 3.0% by weight; and
colors and flavorings of the balance of the weight;
wherein said rawhide-based product form moldable dough that can be cooked.

2. A method for the production of the rawhide-based product of claim 1, said method consisting essentially of:
a. Dissolving of said powdered rahide into said water;
b. Mixing of said modified corn starch, dextrin, casein, dried fermentation solubles, calcium carbonate, and colors and flavorings with said glyerine;
c. Heating the mix of step b. at 60° C. while mxing;
d. Removing the mix of step c. from heat and combining with the solvated rawhide of step a.;
e. Mixing to a homogeneous paste, or dough;
f. Removed the dough from a mixing vessel and feedign into a hopper of a rotary molder;
wherein said rotary molder shapes said dough into a biscuit shape for baking at a sufficient temperature and time.
